(19) United States
(12) Patent Application Publication
(10) Pub. No.: US 2014/0260545 A1
(43) Pub. Date: Sep. 18, 2014

(54) SENSOR AND SENSING METHOD

(71) Applicant: INFINEON TECHNOLOGIES AG, (US)

(72) Inventors: Guenther Ruhl, Regensburg (DE); Werner Breuer, Sinzing-Viehhausen (DE)

(73) Assignee: INFINEON TECHNOLOGIES AG, Neubiberg (DE)

(21) Appl. No.: 13/834,346

(22) Filed: Mar. 15, 2013

(51) Int. Cl. G01N 27/14

(52) U.S. Cl. CPC G01N 27/14
USPC 73/31.05

(57) ABSTRACT

A sensor is provided, which may include: a sensor layer containing a sensor material, wherein an electrical resistance of the sensor material changes upon adsorption of an adsorbate at the sensor material; a circuit electrically coupled to the sensor layer and configured to apply an electrical current to the sensor layer that heats the sensor layer.

### TECHNICAL FIELD

Various embodiments relate to a sensor and a sensing method.

### BACKGROUND

Sensors may be used to detect the presence of certain substances such as gases. Gas sensors may be sensitive to air moisture, which may have an adverse effect on the sensor performance. Increasing the sensor temperature may reduce a gas sensor's sensitivity to air moisture. Accordingly, it may be desirable to provide heating of the gas sensor.

### SUMMARY

A sensor is provided, which may include: a sensor layer containing a sensor material, wherein an electrical resistance of the sensor material changes upon adsorption of an adsorbate at the sensor material; a circuit electrically coupled to the sensor layer and configured to apply an electrical current to the sensor layer that heats the sensor layer.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a diagram illustrating a gas sensor's response to air moisture as a function of the sensor temperature;

FIG. 2 shows a diagram illustrating a dependence of a gas sensor's regeneration period on the sensor temperature;

FIG. 3 shows a conventional gas sensor with external heater;

FIG. 4 shows a sensor according to various embodiments;

FIG. 5 shows a sensor with a substrate including a semiconductor layer and an insulating layer, according to various embodiments;

FIG. 6 shows a sensor with a substrate and a sensor layer suspended over a cavity in the substrate, according to various embodiments;

FIG. 7 shows a sensor with a substrate and a sensor layer attached to a carrier membrane suspended over a cavity in the substrate, according to various embodiments;

FIG. 8 shows a sensor with a sensor layer and electrodes coupled to the sensor layer, according to various embodiments;

FIG. 9 shows a sensor with a separate heating layer;

FIG. 10 shows a flow diagram illustrating a method for sensing according to various embodiments.

### DESCRIPTION

The following detailed description refers to the accompanying drawings that show, by way of illustration, specific details and embodiments in which the invention may be practised. These embodiments are described in sufficient detail to enable those skilled in the art to practice the invention. Other embodiments may be utilized and structural, logical, and electrical changes may be made without departing from the scope of the invention. The various embodiments are not necessarily mutually exclusive, as some embodiments can be combined with one or more other embodiments to form new embodiments. Various embodiments are described in connection with methods and various embodiments are described in connection with devices. However, it may be understood that embodiments described in connection with methods may similarly apply to the devices, and vice versa.

The word “exemplary” is used herein to mean “serving as an example, instance, or illustration”. Any embodiment or design described herein as “exemplary” is not necessarily to be construed as preferred or advantageous over other embodiments or designs.

The terms “at least one” and “one or more” may be understood to include any integer number greater than or equal to one, i.e. one, two, three, four, etc.

The term “a plurality” may be understood to include any integer number greater than or equal to two, i.e. two, three, four, five, etc.

The word “over”, used herein to describe forming a feature, e.g. a layer “over” a side or surface, may be used to mean that the feature, e.g. the layer, may be formed “directly on”, e.g. in direct contact with, the implied side or surface. The word “over”, used herein to describe forming a feature, e.g. a layer “over” a side or surface, may be used to mean that the feature, e.g. the layer, may be formed “indirectly on” the implied side or surface with one or more additional layers being arranged between the implied side or surface and the formed layer.

The term “coupling” or “connection” may include both an indirect “coupling” or “connection” and a direct “coupling” or “connection”.

The following description will mainly focus on the sensors that use graphene as a sensor material. However, it may be understood that considerations taken herein below may equally apply to other sensors or sensor materials, and may for example generally apply to sensor materials whose electrical resistance (or resistivity) may change upon adsorption of an adsorbate (e.g. gas molecule(s)) at the surface of the sensor material, for example two-dimensional materials such as graphene, molybdenum sulphide, tungsten sulphide, or the like, or metal oxides such as tin dioxide, zinc oxide, titanium dioxide, or the like.

Graphene is a novel material that may, for example, be used for fabrication of a gas sensor. The measurement principle of a graphene-based gas sensor is based on a change in a graphene layer's electrical resistance upon adsorption of gas molecules. At room temperature, these gas sensors may be also sensitive to air moisture, which may influence a measurement result accordingly. The sensitivity to air moisture may be greatly reduced by increasing the sensor temperature to about 100° C. or above, as may be seen from FIG. 1.

FIG. 1 shows a diagram 100 illustrating a graphene-based gas sensor's response to air moisture as a function of the sensor temperature.

The different curves show the sensor response, plotted as change of the sensor layer's resistance with exposure time, for a temperature of 40° C. (curve 101), 60° C. (curve 102), 80° C. (curve 103), 100° C. (curve 104), 110° C. (curve 105), 120° C. (curve 106), 130° C. (curve 107), and 140° C. (curve 108).

Point 110 indicates a first point in time where exposure of the sensor to moisture is started (“H₂O on”), and point 120 indicates a second point in time where exposure of the sensor to moisture is stopped (“H₂O off”). Upon exposure to moisture, the resistance of the sensor increases, and it decreases again when the moisture exposure is turned off.

As may be seen, the sensitivity to air moisture decreases with increasing sensor temperature and may be sufficiently small for temperatures of about 100° C. or above.

Also, sensitivity to various other gases may depend on the temperature of the sensor. Furthermore, desorption of detected gas molecules and thus a regeneration period of the gas sensor may correlate with the temperature of the sensor, as may be seen from FIG. 2.

FIG. 2 shows a diagram 200 illustrating a dependence of a graphene-based gas sensor's regeneration period on the sensor temperature.

A first curve 201 in diagram 200 shows a normalized resistance R/R₀ of the gas sensor plotted versus time for a sensor temperature of 22° C., and a second curve 202 in diagram 200 shows a normalized electrical resistance R/R₀ of the gas sensor plotted versus time for a sensor temperature of 85° C. At certain points in time, the gas sensor is exposed to a gas, namely NO₂ in the example shown, which leads to adsorption of gas molecules (i.e. NO₂ molecules in this example) at the graphene sensor layer and consequently to a change in the sensor's electrical resistance, i.e. to a rapid decrease from R/R₀≈1 to a value <1 in the example shown, as may be seen from steep drops in curves 201 and 202. After the exposure to the gas is stopped, the adsorbed gas molecules desorb from the sensor layer's surface and the sensor's electrical resistance gradually returns to its initial value. The regeneration period may refer to a time period necessary for the sensor to reach R/R₀≈1 again, for example time period t1 in case of 22° C. sensor temperature, or time period t2 in case of 85° C. sensor temperature, as shown in FIG. 2.

As may be seen from the two different curves 201 and 202 in FIG. 2, the regeneration period may be shortened by increasing the sensor temperature, i.e. t2<t1. In the example shown, adsorption of an adsorbate (i.e. NO₂ molecules in the example shown) at the sensor layer leads to a decrease of the sensor's resistance. However, it may also be possible that adsorption of an adsorbate at the sensor layer increases the sensor's resistance. Whether the presence of an adsorbate at the sensor layer increases or decreases the sensor layer's resistance may, for example, depend on the adsorbate's impact on the sensor material's electron density distribution, e.g. whether the adsorbate serves as a donor or acceptor.

The regeneration periods t1, t2 of the sensor according to the example of FIG. 2 are of the order of several minutes. However, it should be noted that the regeneration period of a gas sensor according to other examples may be different, and may for example be shorter, for example of the order of seconds, or even shorter.

Due to the aforementioned reasons it may be useful to heat the sensor to temperatures of up 100° C. or above.

In conventional gas sensors, heating of the sensor is achieved by an external heater, for example by means of metal or silicon conducting tracks disposed below and insulated by a dielectric, as schematically shown in FIG. 3.

FIG. 3 shows a gas sensor 300 including a substrate 301 (e.g. silicon substrate), a dielectric layer 302 (e.g. silicon oxide layer) disposed over the substrate 301, a sensor layer 303 containing a sensor material (e.g. graphene) disposed over the dielectric layer 302, and an external heater 304 (including, for example, one or more metal tracks) disposed below the sensor layer 303 and insulated from the sensor layer 303 by the dielectric layer 302. The sensor layer 303 may be coupled to a circuit (not shown) that may be configured to measure the electrical resistance of the sensor layer 303. The heater 304 may be coupled to a circuit (not shown) that may be configured to apply an electrical current to the heater 304 to heat the heater 304 and thus the sensor layer 303 of the sensor 300.

Heating with an external heater, such as heater 304 in FIG. 3, may not only lead to a relatively complex design of the sensor chip with additional metal and dielectric levels, but also to a high loss of heat due to the insulation via the dielectric.

Thus, it may be desirable to provide a sensor (e.g. gas sensor) heating with less complex design. Furthermore, it may be desirable to provide a sensor (e.g. gas sensor) heating with reduced loss of heat.

In accordance with an aspect of the present disclosure, heating of a sensor (e.g. chemical sensor, e.g. gas sensor) may be achieved by means of the sensor layer itself, for example by means of a graphene layer used as sensor material. For example, by applying a corresponding voltage, an electrical current may flow through the sensor layer (e.g. graphene layer), which, when having a corresponding magnitude, may lead to a temperature increase in the sensor layer (e.g. graphene layer). Graphene, for example, may have an extremely high ampacity (current-carrying capability) of up to 10⁸ A/cm² so that a very high heating output may be generated without destruction of the graphene layer.

According to one or more embodiments, a sensor layer or sensor material (e.g. graphene layer) may serve as a sensor element (e.g. gas sensor element), and at the same time as a heating element of a sensor (e.g. gas sensor).

According to one or more embodiments, the use of a graphene layer (or other sensor material) as both sensor element and heating element in a device or component (e.g. sensor chip) may have the effect that a separate heating may be saved.

An effect of one or more embodiments may be a significantly simpler design of a sensor element due to omission of an additional heating structure. Another effect of one or more embodiments may be a lower heat loss due to the generation of heat in the sensor material (e.g. graphene) itself.

FIG. 4 shows a sensor 400 in accordance with various embodiments.

The sensor 400 may include a sensor layer 403 containing a sensor material, wherein an electrical resistance of the sensor material changes upon adsorption of an adsorbate at the sensor material. In other words, a value of the electrical resistance of the sensor material may depend on whether an adsorbate (e.g. gas molecules) is present (adsorbed) at the sensor material's surface or not, and may further depend on the amount of adsorbate (e.g. number of gas molecules) present (adsorbed) at the sensor material's surface. The sensor may further include a circuit 405 electrically coupled to the sensor layer 403 and configured to apply an electrical current to the sensor layer 403 that heats the sensor layer 403.

The change in the sensor material's resistance (or resistivity) upon adsorption of an adsorbate may cause a corresponding change in an electrical resistance of the sensor layer 403.

In accordance with one or more embodiments, the electrical coupling between the circuit 405 and the sensor layer 403 may include or may be achieved by at least one electrical connection 405a. The at least one electrical connection 405a may, for example, include at least one electrically conductive track. The at least one electrical connection 405a may, for example include at least one electrode coupled to the sensor layer 403. The at least one electrode may, for example, include or be a planar electrode, or may be at least partially embedded or sunk-in in a substrate 401, or may be covered by the sensor layer 403, or may be disposed over the sensor layer 403.

The circuit 405 may include one or more electrical and/or electronic elements or components, e.g. one or more passive and/or active components, and/or wirings, e.g. one or more conductive tracks, and/or or one or more capacitors, and/or one or more inductors, and/or one or more diodes, and/or one or more transistors, or the like.

The circuit 405 may be configured to control heating of the sensor layer. For example, the control circuit 405 may be configured to set and/or control a temperature of the sensor layer 403.

In accordance with one or more embodiments, the sensor layer 403 may consist of the sensor material.

In accordance with one or more embodiments, the sensor material may have an ampacity of greater than or equal to about 10⁶ A/cm², for example greater than or equal to about 10⁷ A/cm², for example greater than or equal to about 10⁸ A/cm², although other values may be possible as well. In accordance with one or more embodiments, “ampacity” or “current-carrying capacity” may be understood to refer to a maximum amount of electrical current a conductor or device can carry before sustaining immediate or progressive deterioration. As an example, a material having an ampacity of 10⁶ A/cm² may be understood to be a material that can carry an electrical current of up to 10⁶ amperes per cm² before sustaining immediate or progressive deterioration.

In accordance with one or more embodiments, the sensor material may contain or may be a two-dimensional material.

The term “two-dimensional material” as used herein may, for example, be understood to include or refer to a material that crystallizes in a two-dimensional or planar structure, wherein a first geometric dimension (e.g. thickness) of the structure may be substantially smaller, e.g. at least two orders of magnitude smaller, e.g. at least three orders of magnitude smaller, e.g. at least four orders of magnitude smaller, or even smaller, than a second geometric dimension (e.g. length) and/or a third geometric dimension (e.g. width) of the structure. In one or more embodiments, the term “two-dimensional material” may be understood to include or refer to a material having the thinnest possible structure (one individual layer) derived from a material composed of several layers, e.g. a one carbon atom thick layer as for graphene, or a one MoS₂ unit thick layer as for MoS₂.

In accordance with one or more embodiments, the two-dimensional material may contain or may be graphene.

In accordance with one or more embodiments, the graphene may include or may be functionalized graphene.

The term “functionalized graphene” may be understood to include or refer to chemically modified graphene or graphene having a decoration or contiguous layer of another material (e.g. nano particles), which may serve to achieve selectivity towards specific adsorbates, e.g. specific atoms, molecules or ions.

In accordance with one or more embodiments, the functionalized graphene may contain nanoparticles, for example metal nanoparticles, for example platinum (Pt) nanoparticles or nickel (Ni) nanoparticles or inorganic compound particles, for example metal oxide nanoparticles, for example manganese dioxide (MnO₂) nanoparticles or titanium dioxide TiO₂ nanoparticles.

In accordance with one or more embodiments, the functionalized graphene may include or may be chemically functionalized graphene. In accordance with one or more embodiments, the chemically functionalized graphene may include one or more functional groups, e.g. one or more carboxyl groups, and/or one or more amino groups, and/or the like.

In accordance with one or more embodiments, the two-dimensional material may contain or may be a two-dimensional semiconducting material, in other words a two-dimensional material having semiconducting properties.

In accordance with one or more embodiments, the two-dimensional material may contain or may be a two-dimensional chalcogenide material, e.g. molybdenum disulphide, or tungsten disulphide.

In accordance with one or more embodiments, the sensor material may contain or may be a metal oxide, e.g. tin dioxide (SnO₂), zinc oxide (ZnO), or titanium dioxide (TiO₂).

In accordance with one or more embodiments, the sensor layer 403 (e.g. a graphene layer) may have a thickness of less than or equal to about 200 nm, for example less than or equal to about 100 nm, for example less than or equal to about 80 nm, for example less than or equal to about 60 nm, for example less than or equal to about 40 nm, for example less than or equal to about 20 nm, for example in the range from about 0.5 nm to about 50 nm, for example about 0.34 nm (e.g. in case the sensor layer 403 consists of a single monolayer of graphene).

In accordance with one or more embodiments, the sensor 400 may be configured as, or may be, a chemical sensor. For example, the sensor 400 may be utilized in (or exposed to) gases and/or liquids.

In accordance with one or more embodiments, the sensor 400 may be configured as, or may be, a gas sensor. In other words, the sensor 400 may be configured to detect or sense a gas or gases.

In accordance with one or more embodiments, the gas sensor may be configured to detect or sense combustible and/or non-combustible gases.

In accordance with one or more embodiments, an electron density distribution in the sensor material may change upon adsorption of an adsorbate (e.g. gas molecules) at the sensor material.

In accordance with one or more embodiments, the sensor 400 may include a substrate 401, wherein the sensor layer 403 may be disposed over, e.g. attached to, the substrate 401, as shown.

In accordance with one or more embodiments, the sensor layer 403 may have a first side 403a and a second side 403b opposite the first side 403a, wherein the first side 403a may face away from the substrate 401 and the second side 403b may face the substrate 401, as shown.

In accordance with one or more embodiments, the first side 403a of the sensor layer 403 may be exposed to an adsorbate.

In accordance with one or more embodiments, the adsorbate may be adsorbed at the first side 403a of the sensor layer 403.

In accordance with one or more embodiments, the second side 403b of the sensor layer may be attached to the substrate 401.

In accordance with one or more embodiments, the substrate 401 may include an insulating layer (e.g. electrically insulating layer) or may be an insulating substrate (e.g. electrically insulating substrate), for example a substrate containing or consisting of silicon dioxide, for example a glass substrate, for example a substrate containing or consisting of silicon nitride, for example a substrate containing or consisting of aluminum oxide.

In accordance with one or more embodiments, the substrate 401 may have a thickness in the range from about 1 μm to about 1000 μm.

In accordance with one or more embodiments, the substrate 401 may include a semiconductor layer and an insulating layer (e.g. electrically insulating layer) disposed over the semiconductor layer, wherein the sensor layer 403 may be disposed over the insulating layer (not shown, see e.g. FIG. 5).

In accordance with one or more embodiments, the substrate 401 may include a cavity, wherein the sensor layer 403 may be suspended over the cavity (not shown, see e.g. FIG. 6).

In accordance with one or more embodiments, the sensor may include a carrier membrane (also referred to as carrier substrate membrane) suspended over the cavity, wherein the sensor layer may be attached to the carrier membrane (not shown, see e.g. FIG. 7).

In accordance with one or more embodiments, the electrical current applied by the circuit 405 may flow through the sensor layer 403 and thus heat the sensor layer 403.

In accordance with one or more embodiments, the electrical current may heat the sensor layer 403 to a temperature substantially higher than room temperature, e.g. to a temperature of at least about 50° C., e.g. to a temperature of at least about 60° C., e.g. to a temperature of at least about 80° C., e.g. to a temperature of at least about 100° C., e.g. to a temperature of at least about 110° C., e.g. to a temperature of at least about 120° C., e.g. to a temperature of at least about 130° C., e.g. to a temperature of at least about 140° C., e.g. to a temperature of at least about 150° C., e.g. to a temperature in the range from about 100° C. to about 150° C., e.g. in case of a sensor layer containing or consisting of graphene, or to a temperature of at least about 400° C., e.g. to a temperature of up to 800° C., e.g. to a temperature in the range from about 400° C. to about 600° C., e.g. in case of a sensor layer containing or consisting of a metal oxide.

In accordance with one or more embodiments, the circuit 405 may further be configured to measure an electrical resistance of the sensor layer 403.

In accordance with one or more embodiments, the circuit 405 may be configured to measure the electrical resistance of the sensor layer using the electrical current.

In accordance with one or more embodiments, the electrical current may include or may be a direct current (DC).

In accordance with one or more embodiments, the electrical current may include or may be an alternating current (AC).

In accordance with one or more embodiments, the electrical current may be a first electrical current, wherein the circuit 405 may further be configured to apply a second electrical current different from the first electrical current to the sensor layer 403, and to measure an electrical resistance of the sensor layer 403 using the second electrical current.

The first electrical current may be referred to as a heating current. The second electrical current may be referred to as a measurement current or sensing current.

In accordance with one or more embodiments, the second electrical current may flow through the sensor layer 403, wherein the sensor layer 403 is not substantially heated by the second electrical current.

In accordance with one or more embodiments, the second electrical current may have a lower amperage than the first electrical current, e.g. at least one order of magnitude lower than the first electrical current, e.g. at least two orders of magnitude lower than the first electrical current, e.g. at least three orders of magnitude lower than the first electrical current, or more than three orders of magnitude lower than the first electrical current.

In accordance with one or more embodiments, the second electrical current may include or may be a direct current (DC).

In accordance with one or more embodiments, the second electrical current may include or may be an alternating current (AC).

In accordance with one or more embodiments, the circuit 405 may be configured to alternately apply the first electrical current and the second electrical current to the sensor layer 403.

In accordance with one or more embodiments, the sensor may include at least one electrode (e.g. at least two electrodes, e.g. a plurality of electrodes) electrically coupled to the sensor layer 403 (not shown, see e.g. FIG. 8).

FIG. 5 shows a sensor 500 in accordance with various embodiments.

The sensor 500 is to some degree similar to the sensor 400 of FIG. 4. In particular, the same reference signs may denote the same or similar elements as there and will not be described in detail again here for sake of brevity. Reference is made to the description above.

In the sensor 500, the substrate 401 includes a semiconductor layer 401′ and an insulating layer 401″ disposed over the semiconductor layer 401′, wherein the sensor layer 403 is disposed over the insulating layer 401″. The sensor layer 403 may be attached to the insulating layer 401″.

The semiconductor layer 401′ may include or may consist of a semiconducting material. The semiconductor layer 401′ may be a silicon layer. The semiconductor layer 401′ may be a silicon carbide layer. The semiconductor layer 401′ may be a germanium layer. The semiconductor layer 401′ may be a compound semiconductor layer, for example a III-V compound semiconductor layer, e.g. a gallium nitride layer or a gallium arsenide layer.

The insulating layer 401″ may include or may consist of an insulating material, e.g. an electrically insulating material. The insulating layer 401″ may be an oxide layer, e.g. a silicon oxide or aluminum oxide layer. The insulating layer 401″ may be a nitride layer, e.g. a silicon nitride or boron nitride layer or carbon-based materials with low thermal conductivity, e.g. nanocrystalline diamond.

FIG. 6 shows a sensor 600 in accordance with various embodiments.

The sensor 600 is to some degree similar to the sensor 400 of FIG. 4. In particular, the same reference signs may denote the same or similar elements as there and will not be described in detail again here for sake of brevity. Reference is made to the description above.

In the sensor 600, the substrate 401 has a cavity 406, wherein the sensor layer 403 is suspended over the cavity 406.

In accordance with one or more embodiments, the sensor layer 403 may be attached to the substrate 401 along a perimeter of the cavity 406.

The cavity 406 may provide a thermal isolation for the sensor layer 403. In other words, the cavity 406 may serve to reduce or prevent loss of the heat that is generated in the sensor layer 403.

FIG. 7 shows a sensor 700 in accordance with various embodiments.

The sensor 700 is to some degree similar to the sensor 600 of FIG. 6. In particular, the same reference signs may denote the same or similar elements as there and will not be described in detail again here for sake of brevity. Reference is made to the description above.

In the sensor 700, the sensor layer 403 is attached to a carrier membrane 407, which is suspended over the cavity 406. The carrier membrane 407 may have a first side 407a facing the sensor layer 403 and a second side 407b opposite the first side 407a and facing the substrate 401. The sensor layer 403 may be attached to the first side 407a of the carrier membrane 407.

In accordance with one or more embodiments, the carrier membrane 407 may be attached to the substrate 401 along a perimeter of the cavity 406.

In accordance with one or more embodiments, the carrier membrane 407 may contain or may consist of an insulating material (e.g. electrically insulating material), for example an oxide (e.g. silicon oxide, e.g. SiO₂) or aluminum oxide (Al₂O₃) or a nitride (e.g. silicon nitride, e.g. Si₃N₄) or boron nitride BN or carbon-based materials with low thermal conductivity, e.g. nanocrystalline diamond.

In accordance with one or more embodiments, the carrier membrane 407 may have a thickness of several microns, for example a thickness of less than or equal to about 100 μm, e.g. less than or equal to about 50 μm, e.g. less than or equal to about 20 μm, e.g. less than or equal to about 10 μm, e.g. less than or equal to about 5 μm, e.g. less than or equal to about 1 μm, e.g. in the range from about 1 μm to about 100 μm, e.g. in the range from about 1 μm to about 50 μm, e.g. in the range from about 1 μm to about 20 μm, e.g. in the range from about 1 μm to about 10 μm, e.g. in the range from about 1 μm to about 5 μm, e.g. in the range from about 10 μm to about 50 μm.

FIG. 8 shows a sensor 800 in accordance with various embodiments.

The sensor 800 is to some degree similar to the sensor 700 of FIG. 7. In particular, the same reference signs may denote the same or similar elements as there and will not be described in detail again here for sake of brevity. Reference is made to the description above.

The sensor 800 includes at least one electrode, e.g. a plurality of electrodes, 408 that may be electrically coupled to the sensor layer 403. The at least one electrode 408 may be disposed over the carrier membrane 407, e.g. over the first side 407a of the carrier membrane 407, as shown.

In accordance with one or more embodiments, the sensor layer 403 may be in contact (e.g. physical contact, e.g. direct physical contact) with the at least one electrode 408.

In accordance with one or more embodiments, the sensor layer 403 may be disposed over the at least one electrode 408.

In accordance with one or more embodiments, the at least one electrode 408 may be at least partially, e.g. fully, embedded in the sensor layer 403.

In accordance with one or more embodiments, the at least one electrode 408 may include or may consist of at least one electrically conductive material, for example a metal or metal alloy such as copper, aluminum, gold, platinum, an alloy containing at least one of the aforementioned metals, an electrically conductive compound, e.g. a metal nitride such as titanium nitride or tantalum nitride, or electrically conductive carbon.

In accordance with one or more embodiments, the at least one electrode 408 may be configured and/or arranged to carry out a four-point measurement of the electrical resistance of the sensor layer 403.

In accordance with one or more embodiments, the at least one electrode 408 may be configured and/or arranged to carry out a two-point measurement of the electrical resistance of the sensor layer 403.

In accordance with one or more embodiments, the at least one electrode 408 may be electrically coupled to the circuit 405.

A method for manufacturing a sensor in accordance with various embodiments, for example having a similar structure as sensor 800, may include: providing a carrier substrate, e.g. a carrier membrane (e.g. a freely suspended silicon oxide (e.g. SiO₂) or silicon nitride (e.g. Si₃N₄) membrane of e.g. a few microns thickness); forming one or more electrode structures or electrodes, over the carrier substrate (the electrode structures or electrodes may include or consist of an electrically conductive material, for example a metal or metal alloy (e.g. Au and/or Pt), an electrically conductive compound (e.g. TiN and/or TaN), or electrically conductive carbon); depositing a layer, which includes or consists of a sensor material (e.g. a two-dimensional material such as graphene, MoS₂, or WS₂) onto the one or more electrode structures or electrodes. The layer including or consisting of the sensor material may be referred to as sensor layer.

In an example, the sensor layer may include graphene or may be a graphene layer.

Suitable deposition processes for depositing a graphene layer may include, but are not limited to, deposition and drying or annealing of a graphene or graphene oxide suspension, or transfer of one or more graphene layers previously deposited on a temporary substrate.

The graphene layer may, for example, be formed with the use of one or more of the following processes:

a) Chemical reduction of graphene oxide (e.g. exfoliated graphene oxide), known as such from, e.g., “S. Stankovich et al., Synthesis of graphene-based nanosheets via chemical reduction of exfoliated graphite oxide, Carbon 45 (2007) 1558”, or “D. Li et al., Processable aqueous dispersions of graphene nanosheets, Nature Nanotechnology 3 (2008) 101”, the contents of all of which are hereby incorporated by reference in their entirety;

b) Chemical Vapor Deposition (CVD) of graphene, known as such from, e.g., “X. Li et al., Large-Area Synthesis of High-Quality and Uniform Graphene Films on Copper Foils, Science 324 (2009) 131”, or European patent application publication EP 2 055 673 A1, or United States patent application publication US 2009/0155561 A1, the contents of all of which are hereby incorporated by reference in their entirety;

c) Formation of graphene utilizing solid phase carbon sources, known as such from, e.g., United States patent application publication US 2011/0206934 A1, or “Z. Sun et al., Growth of graphene from solid carbon sources, Nature 468 (2010) 549”, the contents of all of which are hereby incorporated by reference in their entirety;

d) Solid state epitaxial growth of graphene, known as such from, e.g., U.S. Pat. No. 7,015,142 B2, or International patent application publication WO 2010/096646 A2, the contents of all of which are hereby incorporated by reference in their entirety;

e) Process b), c), or d), as mentioned above, in combination with a transfer process onto the desired substrate (e.g. the carrier substrate, e.g. carrier membrane), known as such from, e.g., European patent application publication EP 2 055 673 A1, or “K. S. Kim et al., Large-scale pattern growth of graphene films for stretchable transparent electrodes, Nature 457 (2008) 706”, the contents of which are hereby incorporated by reference in their entirety.

The graphene layer may, for example, include or consist of a plurality of crystallites or flakes that may, for example, have a size (e.g. diameter) of a few micrometers, e.g. about 1 μm. Each of the crystallites may, for example, include or consist of one or more platelets that may, for example, include or consist of a few layers of graphene, e.g. up to five layers, e.g. a monolayer, bilayer, a trilayer, etc., of graphene, wherein a monolayer of graphene may have a two-dimensional structure with a thickness of about 0.34 nm. In one or more embodiments, the graphene layer may be a single monolayer of graphene.

The graphene layer may also include or consist of functionalized graphene, as described herein above, to achieve selectivity towards specific atoms, molecules or ions. The functionalization of the graphene may be generated before or after the graphene is applied onto the carrier substrate (e.g. carrier membrane).

A method of operating a sensor in accordance with one or more embodiments described herein may include heating the sensor layer and measuring the electrical resistance of the sensor layer.

The electrical circuitry or wiring of a sensor in accordance with one or more embodiments may be implemented both as a two-point measurement or as a four-point measurement of the sensor layer's (e.g. the graphene layer's) electrical resistance as sensor function, which may be dependent on the chemical environment (e.g. on the presence and/or amount of adsorbates, e.g. gas molecules, at the sensor layer's surface). The heating functionality may, for example, be implemented by means of additional electrode contacts, wherein a combination with the four-point measurement of the resistance may be possible. Measuring the electrical resistance of the sensor layer and introducing the heating power into the sensor layer may in each case be realized by application of a direct current (DC) or an alternating current (AC), or a combination of both types of current.

A sensor in accordance with one or more embodiments may be used as a chemical sensor in general, that is both in gases and in liquids.

In accordance with the embodiments described herein above in connection with FIGS. 4 to 8, heating and sensing functionality of a sensor may be implemented by one and the same structure, namely the sensor layer 403 containing e.g. a sensor material having a high ampacity that may carry a heating current with relatively high amperage. Thus, a separate heating structure (e.g. heating layer) may be saved, which may simplify the sensor design. In addition, heat losses may be reduced or avoided.

In accordance with one or more embodiments, heating and sensing functionality of a sensor may also be implemented by separate, e.g. electrically insulated, structures, as shown in FIG. 9.

FIG. 9 shows a sensor 900 in accordance various embodiments.

The sensor 900 is to some degree similar to the sensor 700 of FIG. 7. In particular, the same reference signs may denote the same or similar elements as there and will not be described in detail again here for sake of brevity. Reference is made to the description above.

In the sensor 900, the heating structure and the sensor structure are implemented as separate structures. That is, the sensor 900 may include the sensor layer 403, and a separate heating layer 404 that may be disposed proximate the sensor layer 403, as shown.

The heating layer 404 may be electrically insulated from the sensor layer, for example by a gap and/or a dielectric layer disposed between the heating layer 404 and the sensor layer 403.

A width of the gap and/or dielectric layer between the heating layer 404 and the sensor layer 403 may, for example, be less than or equal to about 50 μm, e.g. in the range from about 0.5 μm to about 10 μm.

The sensor layer 403 may contain or consist of a sensor material, for example any one of the sensor materials described herein, for example a two-dimensional material, for example graphene, or a two-dimensional semiconducting material, e.g. MoS₂ or WS₂.

The heating layer 404 may contain or consist of a two-dimensional material, for example any one of the two-dimensional materials described herein, for example graphene, or a two-dimensional semiconducting material, e.g. MoS₂ or WS₂.

In one or more embodiments, the sensor layer 403 and the heating layer 404 may include or consist of the same material.

For example, in one or more embodiments, the sensor layer 403 and the heating layer 404 may both include or consist of graphene.

In one or more embodiments, the heating layer 404 may include or consist of non-functionalized graphene and the sensor layer 403 may include or consist of functionalized graphene.

The sensor 900 may further include a circuit 905 electrically coupled to the heating layer 404 and configured to apply an electrical current to the heating layer 404 to heat the sensor layer 403. For example, by means of the electrical current applied to the heating layer 404, the heating layer 404 may be heated, thereby heating the sensor layer 403 due to the proximity to the heating layer 404.

In accordance with one or more embodiments, the electrical coupling between the circuit 905 and the heating layer 404 may include or may be achieved by at least one electrical connection 405b. The at least one electrical connection 405b may, for example, include at least one electrically conductive track. The at least one electrical connection 405b may, for example include at least one electrode coupled to the heating layer 404.

The circuit 905 may include one or more electrical and/or electronic elements or components, e.g. passive and/or active components, and/or wirings, e.g. one or more conductive tracks, and/or or one or more capacitors, and/or one or more inductors, and/or one or more diodes, and/or one or more transistors.

The circuit 905 may be configured to control heating of the sensor layer 403. The circuit 905 may further be configured to measure an electrical resistance of the sensor layer 403.

To this end, the circuit 905 may further be electrically coupled to the sensor layer 403, e.g. by means of at least one electrical connection 405a, e.g. similarly as described herein above for the circuit 405. The circuit 905 may apply an electrical current to the sensor layer 403 to measure the sensor layer 403's electrical resistance, e.g. in a similar manner as described herein above with circuit 405.

In accordance with one or more embodiments, the sensor layer 403 and the heating layer 404 may be disposed in the same plane, or substantially the same plane, as shown.

In accordance with one or more embodiments, the sensor layer 403 may be disposed between the heating layer 404, e.g. laterally between the heating layer 404, e.g. between a first portion 404′ of the heating layer 404 and a second portion 404″ of the heating layer 404, as shown.

The heating layer 404 may have a first side 404a and a second side 404b opposite the first side 404a, wherein the first side 404a may face away from the substrate 401 and the second side 404b may face the substrate 404, as shown. In the example shown, the heating layer 404 may disposed over the carrier membrane 407, with the second side 404b of the heating layer 404 facing the first side 407a of the carrier membrane 407.

In accordance with one or more embodiments, the sensor layer 403 and the heating layer 404 may have been formed by a single deposition process, for example any one of the deposition processes described herein above for forming a graphene layer. For example, the sensor layer 403 and the heating layer 404 may have been formed as a single contiguous layer initially, e.g. as a single contiguous graphene layer, and the single contiguous layer may have been patterned subsequently to form the sensor layer 403 and the heating layer 404 separated from each other.

An effect of the sensor 900 may be seen in that the heating structure (heating layer 404) may be disposed in the same plane, or substantially the same plane, as the sensor structure (sensor layer 403). Thus, a design of the sensor may be simplified compared to the conventional sensor 300 with external heater 304 shown in FIG. 3. Furthermore, the same material may be used for both the sensor structure (sensor layer 403) and the heating structure (heating layer 404), for example graphene, which may for example be deposited in a single deposition process. However, it is also possible to use different materials, for example functionalized graphene as sensor material and non-functionalized graphene as heating material.

In accordance with one or more embodiments, at least one of the sensor layer 403 and the heating layer 404 (in other words, the sensor layer 403 and/or the heating layer 404) may have a small thickness, for example a thickness of less than or equal to about 200 nm, for example less than or equal to about 100 nm, for example less than or equal to about 80 nm, for example less than or equal to about 60 nm, for example less than about 40 nm, for example less than about 20 nm, for example less than about 10 nm, for example less than about 5 nm, for example less than about 1 nm, for example in the range from about 0.5 nm to about 50 nm.

FIG. 10 shows a diagram illustrating a sensing method 1000 in accordance with various embodiments.

Method 1000 may include: providing a sensor having a sensor layer containing a sensor material, wherein an electrical resistance of the sensor material changes upon adsorption of an adsorbate at the sensor material (in 1020); applying an electrical current to the sensor layer that heats the sensor layer (in 1040); exposing the heated sensor layer to an adsorbate (in 1060); measuring an electrical resistance of the heated sensor layer (in 1080).

The sensor may, for example, be configured in accordance with one or more embodiments described herein.

In accordance with one or more embodiments, the electrical current may include or may be a direct current (DC). In accordance with one or more embodiments, the electrical current may include or may be an alternating current (AC).

In accordance with one or more embodiments, the sensor material may include or may be a two-dimensional material.

In accordance with one or more embodiments, the two-dimensional material may include or may be graphene.

In accordance with one or more embodiments, the graphene may include or may be functionalized graphene.

In accordance with one or more embodiments, the functionalized graphene may contain nanoparticles, e.g. metal nanoparticles, e.g. platinum nanoparticles or nickel nanoparticles, or inorganic compound particles, for example metal oxide nanoparticles, for example manganese dioxide (MnO₂) nanoparticles or titanium dioxide TiO₂ nanoparticles.

In accordance with one or more embodiments, the two-dimensional material may include or may be a semiconducting two-dimensional material.

In accordance with one or more embodiments, the two-dimensional material may include or may be a chalkogenide material, e.g. molybdenum disulphide (MoS₂) or tungsten disulphide (WS₂).

In accordance with one or more embodiments, the sensor layer may have a thickness of less than or equal to about 200 nm, for example less than or equal to about 100 nm, for example less than or equal to about 80 nm, for example less than or equal to about 60 nm, for example less than about 40 nm, for example less than about 20 nm, for example less than about 10 nm, for example less than about 5 nm, for example less than about 1 nm, for example in the range from about 0.5 nm to about 50 nm.

In accordance with one or more embodiments, the sensor may be configured as (or may be) a chemical sensor.

In accordance with one or more embodiments, the sensor may be configured as (or may be) a gas sensor.

In accordance with one or more embodiments, exposing the heated sensor layer to an adsorbate may include exposing the heated sensor layer to a fluid.

In accordance with one or more embodiments, exposing the heated sensor layer to an adsorbate may include exposing the heated sensor layer to a gas.

In accordance with one or more embodiments, the electrical current may heat the sensor layer to a temperature of at least about 100° C., for example to a temperature in the range from about 100° C. to about 150° C.

In accordance with one or more embodiments, measuring an electrical resistance of the heated sensor layer may include measuring the electrical resistance of the heated sensor layer using the electrical current.

In accordance with one or more embodiments, the electrical current may be a first electrical current, wherein measuring an electrical resistance of the heated sensor layer may include applying a second electrical current different from the first electrical current to the sensor layer, and measuring the electrical resistance of the sensor layer using the second electrical current.

In accordance with one or more embodiments, the second electrical current may be configured such that the sensor layer is not substantially heated by the second electrical current.

In accordance with one or more embodiments, the second electrical current may have a lower amperage than the first electrical current.

In accordance with one or more embodiments, applying the first and second electrical currents to the sensor layer may include alternately applying the first and second electrical currents to the sensor layer.

In accordance with one or more embodiments, alternately applying the first and second electrical currents to the sensor layer may include applying the first and second electrical currents as alternating pulses.

In accordance with one or more embodiments, a pulse duration of the first electrical current (e.g. heating current) may be in the range from about 1 μs to about 100 ms.

In accordance with one or more embodiments, a pulse duration of the second electrical current (e.g. measurement current) may be in the range from about 1 μs to about 100 ms.

In accordance with one or more embodiments, the second electrical current may include or may be a direct current (DC). In accordance with one or more embodiments, the second electrical current may include or may be an alternating current (AC).

In accordance with various embodiments, a graphene layer may serve as a sensor layer of a sensor (e.g. chemical sensor, e.g. gas sensor) and at the same time as a heating element of the sensor. To this end, an electrical current may be applied to the graphene layer to heat the graphene layer. A heating power generated by the graphene layer when applying the electrical current to the graphene layer may be sufficient to heat the graphene layer (and/or the sensor) to a temperature of at least 100° C., for example to a temperature in the range from about 100° C. to about 150° C., or even higher. For example, in an example where the graphene layer is attached to a thin freely suspended carrier membrane (e.g. oxide membrane), a heating power generated by the graphene layer may be sufficient to heat the graphene layer (and/or the sensor) to a temperature of several hundred degrees Celsius. The heating power applied to heat the sensor to a certain temperature may, in general, depend on the specific sensor design. For example, heating a sensor, in which the graphene layer is attached to a thin oxide membrane suspended over a cavity, to a certain temperature may be achieved with a lower heating power than heating a sensor with a different design to the same temperature, e.g. a sensor, in which the graphene layer is attached to a glass substrate or to an oxide layer disposed over a semiconductor substrate.

A sensor in accordance with various embodiments may include: a sensor layer containing graphene; a circuit electrically coupled to the sensor layer and configured to apply an electrical heating current to the sensor layer that heats the sensor layer.

In accordance with one or more embodiments, the sensor layer may consist of graphene.

In accordance with one or more embodiments, the sensor may be a chemical sensor, for example a gas sensor.

While various aspects of this disclosure have been particularly shown and described with reference to specific embodiments, it should be understood by those skilled in the art that various changes in form and detail may be made therein without departing from the spirit and scope of the disclosure as defined by the appended claims. The scope of the disclosure is thus indicated by the appended claims and all changes which come within the meaning and range of equivalency of the claims are therefore intended to be embraced.

What is claimed is:

1. A sensor, comprising:
a sensor layer comprising a sensor material, wherein an electrical resistance of the sensor material changes upon adsorption of an adsorbate at the sensor material;
a circuit electrically coupled to the sensor layer and configured to apply an electrical current to the sensor layer that heats the sensor layer.

2. The sensor of claim 1, wherein the sensor material comprises an ampacity of greater than or equal to about 10⁶ A/cm².

3. The sensor of claim 1, wherein the sensor material comprises a two-dimensional material.

4. The sensor of claim 3, wherein the two-dimensional material comprises graphene.

5. The sensor of claim 3, wherein the two-dimensional material comprises a chalkogenide material.

6. The sensor of claim 1, wherein the sensor layer has a thickness of less than or equal to about 200 nm.

7. The sensor of claim 1, configured as a chemical sensor.

8. The sensor of claim 1, configured as a gas sensor.

9. The sensor of claim 1, further comprising a substrate, wherein the sensor layer is attached to the substrate.

10. The sensor of claim 9, wherein the substrate comprises a cavity, wherein the sensor layer is suspended over the cavity.

11. The sensor of claim 10, further comprising a carrier membrane suspended over the cavity, wherein the sensor layer is attached to the carrier membrane.

12. The sensor of claim 11, wherein the carrier membrane comprises an electrically insulating material.

13. The sensor of claim 4, wherein the graphene comprises functionalized graphene.

14. The sensor of claim 13, wherein the functionalized graphene comprises nanoparticles.

15. The sensor of claim 1, wherein the electrical current heats the sensor layer to a temperature of at least about 100° C.

16. The sensor of claim 1, wherein the circuit is further configured to measure an electrical resistance of the sensor layer using the electrical current.

17. The sensor of claim 1, wherein the electrical current is a first electrical current, wherein the circuit is further configured to apply a second electrical current different from the first electrical current to the sensor layer, and to measure an electrical resistance of the sensor layer using the second electrical current.

18. The sensor of claim 17, wherein the circuit is configured to alternately apply the first electrical current and the second electrical current to the sensor layer.

19. A sensor, comprising:
a sensor layer comprising a sensor material;
a heating layer disposed proximate the sensor layer, the heating layer comprising a two-dimensional material;
a circuit electrically coupled to the heating layer and configured to apply an electrical current to the heating layer to heat the sensor layer.

20. The sensor of claim 19, wherein the two-dimensional material comprises graphene.

21. The sensor of claim 20, wherein the sensor material comprises graphene.

22. The sensor of claim 19, wherein the sensor material comprises non-functionalized graphene and the two-dimensional material comprises functionalized graphene.

23. The sensor of claim 19, wherein the sensor layer and the heating layer are disposed in the same plane.

24. A sensing method, comprising:
providing a sensor having a sensor layer comprising a sensor material, wherein an electrical resistance of the sensor material changes upon adsorption of an adsorbate at the sensor material;
applying an electrical current to the sensor layer that heats the sensor layer;
exposing the heated sensor layer to an adsorbate;
measuring an electrical resistance of the heated sensor layer.

25. The sensing method of claim 24, wherein measuring an electrical resistance of the heated sensor layer comprises measuring the electrical resistance of the heated sensor layer using the electrical current.

26. The sensing method of claim 24, wherein the electrical current is a first electrical current, wherein measuring an electrical resistance of the heated sensor layer comprises applying a second electrical current different from the first electrical current to the sensor layer, and measuring the electrical resistance of the sensor layer using the second electrical current.

27. The sensing method of claim 26, wherein applying the first and second electrical currents to the sensor layer comprises alternately applying the first and second electrical currents to the sensor layer.
